(19) United States
(12) Patent Application Publication
(10) Pub. No.: US 2022/0087347 A1
(43) Pub. Date: Mar. 24, 2022

(54) Multilayered Garment Revealing Underlayers When Wet

(71) Applicant: Scott Cay, Windermere, FL (US)

(72) Inventor: Scott Cay, Windermere, FL (US)

(73) Assignee: Scott Cay, Windermere, FL (US)

(21) Appl. No.: 17/026,212

(22) Filed: Sep. 19, 2020

(51) Int. Cl. A41D 27/08; A41D 31/04; B32B 5/26

(52) U.S. Cl. CPC A41D 27/08; A41D 31/04; B32B 2307/414; B32B 2437/00; B32B 5/26

(57) ABSTRACT

The present invention comprises of a multi layered upper torso garment with opaque outer layers that become translucent when wet, exposing inner layers decorated with color, pattern, and/or printed graphics. When dried after wet, outer layers will return to an opaque state concealing inner layers.

### CROSS-REFERENCE TO RELATED APPLICATIONS

This application claims the benefit of provisional patent application Ser. No. 62/904,554, filed 2019 Sep. 23 by the present inventor, and titled “Multilayered Garment Revealing Underlayers When Wet.”

### STATEMENT REGARDING FEDERALLY SPONSORED RESEARCH OR DEVELOPMENT

Not Applicable

### THE NAMES OF THE PARTIES TO A JOINT RESEARCH AGREEMENT STATEMENT REGARDING PRIOR DISCLOSURES BY THE INVENTOR OR A JOINT INVENTOR

Not Applicable

### TECHNICAL FIELD

The present invention concerns apparel. More particularly, the invention is directed to a multilayered upper torso garment that changes reflective and transmissive values of external layers when wet, making visible colors and various designs of inner layers of the article's fabric body.

### BACKGROUND

The following is a tabulation of some prior art that presently appears relevant:

U.S. Patents

| Pat. No. | Kind Code | Issue Date | Patentee |
|---|---|---|---|
| 5,435,010 | A4 | 1995 Jul. 25 | May |
| 4,453,274 | A4 | 1984 Jun. 12 | Allen |
| 9,345,270 | A4 | 2016 May 24 | Owen et at |

Foreign Patent Documents

| | Cntry | Kind | | |
|---|---|---|---|---|
| Foreign Doc. Nr. | Code | Code | Pub. Dt. | App or Patentee |
| CN202552110U | CN | | 2012 Nov. 28 | [symbol] |
| WO2000076438A2 | WO | A6 | 2000 Dec. 21 | Pierce et al. |
| JP4557545B2 | JP | B1 | 2010 Oct. 6 | [symbol] |
| DE69820840T2 | DE | C09 | 2004 Dec. 30 | Nakashima |

Current color-changing wearable fabrics utilize either a thermochromic chemical, a photo-sensitive chemical, or a hydro-sensitive chemical in the dye. Such chemistry can be expensive, require special fabric manufacturing processes, or can only color transition once to a permanent state.

### SUMMARY

The present solution is a multi layered fabric garment made up of outer and inner layers. Outer layers are fabrics with a low transmissive and refractive value when dry, but a high transmissive and refractive value when wet by water. Inner layers have colors, patterns, or images printed on a surface facing outer layers.

When dry, the garment will only appear to show colors or patterns of outer layers. When wet, outer layers will become translucent by the increased transmissive and refraction from water molecules held by the fabric. Colors, patterns, or logos of inner layers will become visible through translucent wet outer layers of fabric.

### BRIEF DESCRIPTION OF THE DRAWINGS

FIG. 1 illustrates multiple layers of a garment of different patterns and/or colors;

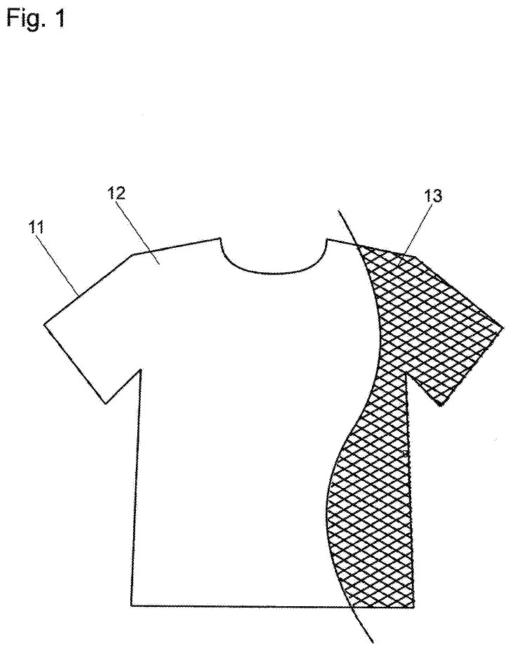

FIG. 2 is a garment of multiple layers where an outer layer is made translucent in part by water wetting the surface and exposing a printed graphic and pattern of an under layer;

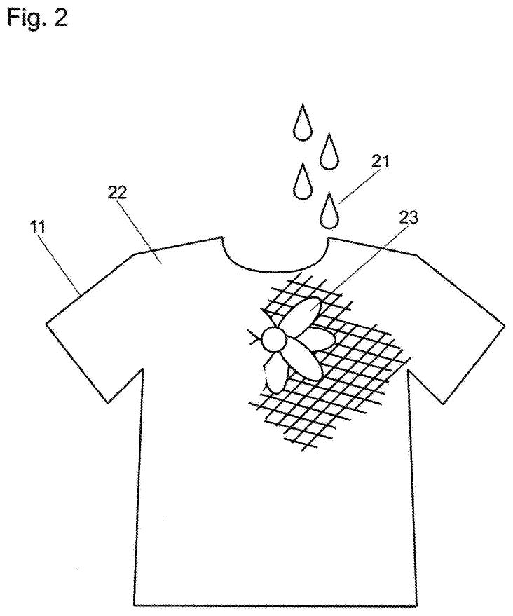

FIG. 3 illustrates light from a source reflecting off dry outer layer area of fabric, and transmitting through wet outer layer areas to reflect off the inner layer of fabric;

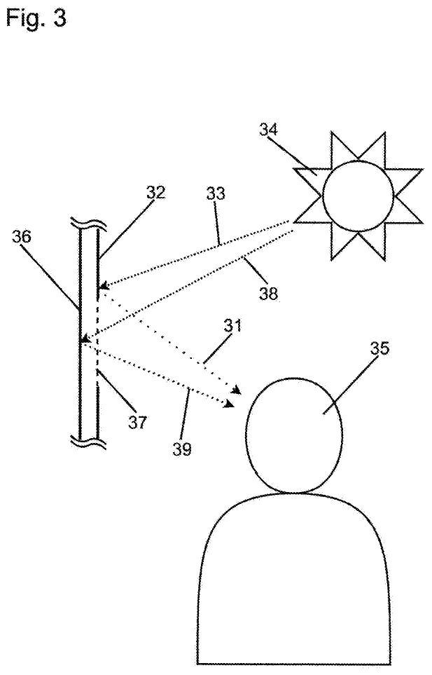

### DETAILED DESCRIPTION OF THE INVENTION

An upper torso garment 11 designed and manufactured of multiple layers. Outer layers 12 are light colored fabric. Inner layers 13 have colors, patterns, or images 23 printed on surfaces facing outer layers. Layers are assembled together to make a single garment.

In a dry state, light colored opaque outer layer fabrics 32 will reflect light 33/31. Inner layer 36 fabric colors, patterns, and/or graphics will not be visible through outer layers. A dry garment will appear as the colors of outer layer fabrics.

Dry outer layers of fabric 32 will reflect light 33/31 from a source 34 to an observer 35. Little light will be transmitted through outer layers to inner layers 36. Majority of light reflected off of inner layers will not pass through outer layers of fabric. Inner layers 36 will be hidden from view by dry outer layers 32.

When wet by water 21, outer layer fabrics 22 will become translucent. inner layer fabric colors, patterns, and/or printed graphics will become visible 23. The wet garment will appear as the color, pattern, and/or decorated with print from inner layer fabrics.

With water, usually opaque outer layers become translucent 37 as light is refracted 38 through water particles suspended in the fabric. Light is transmitted through wet outer layers and reflected, absorbed, or further transmitted by inner layers. Light not absorbed or transmitted by inner layers is reflected out through wet translucent outer layers 37. Reflected light 39 is refracted through water particles to an observer 35. Inner layers will show through wet outer layers.

A wet garment can be dried removing water particles from fabric layers, and decreasing translucency of outer layers. A dried garment will resume to reflect light mostly from outer layers, and inner layers will again be hidden.

What is claimed is:

1) An upper torso garment designed and manufactured with multiple layers revealing underlayers when wet.
